(19) United States
(12) Patent Application Publication
(10) Pub. No.: US 2024/0117079 A1
(43) Pub. Date: Apr. 11, 2024

(54) PROCESSABILITY POLYMER COMPOSITION

(71) Applicant: FINA TECHNOLOGY, INC., Houston, TX (US)

(72) Inventors: Joachim Azzi, Houston, TX (US); Fengkui Li, Houston, TX (US); Mohammad Tuhin, Houston, TX (US)

(73) Assignee: FINA TECHNOLOGY, INC., Houston, TX (US)

(21) Appl. No.: 17/963,562

(22) Filed: Oct. 11, 2022

(51) Int. Cl. C08F 10/02; C08F 10/06

(52) U.S. Cl. CPC C08F 10/02; C08F 10/06

(57) ABSTRACT

A method of adjusting a processing parameter of a polymer is provided. The method has the steps a) and b). Step a) is combining polymer i) which is polypropylene and/or polyethylene with a process aid ii) to provide a polymer composition. Polymer i) has a peak molecular weight Mp and a polydispersity index PDI of 7 or higher. Step b) is processing the polymer composition at a processing condition. The processing parameter is adjusted at the processing condition for the polymer composition compared to a comparative polymer composition A); and a comparative polymer composition B). Comparative polymer composition A) lacks the process aid ii) but is otherwise identical to the polymer composition. Comparative polymer composition B) includes a comparative polymer having the same composition and Mp as polymer i) and a PDI less than polymer i) instead of the polymer i), but is otherwise identical to the polymer composition.

### FIELD OF THE INVENTION

The invention relates to a method of adjusting processing parameters of a polymer by combining the polymer with a processing aid. The invention also relates to a polymer composition including the processing aid and a polymer.

### BACKGROUND

Fluoropolymers have long been used as polymer processing aids (PPA), also referred to as lubricants, for various polymer applications, especially those which require high volume per time extrusion outputs and smooth surfaces. However, due to environmental and regulatory concerns, there is a need to identify methods of reducing the use of fluorinated PPAs. Generally, the process parameters that are affected by the PPAs are incidence of melt fracture, reduced pressure at the die at the same volumetric output, and increased volumetric output at the same pressure at the die compared to a polymer not including the PPA.

Many low weight average molecular weight (Mw) non-fluorinated PPAs work by effectively diluting the polymer, such as polypropylene, thus reducing the overall melt viscosity of the composition. Due to the lower melt viscosity, these PPAs reduce the extrusion pressure at the die and thus increase productivity by permitting a higher extrusion volume output at the same die pressure. However, the mechanical properties of the resulting extruded articles may be negatively impacted, since the lower Mw component (the non-fluorinated processing aid) tends to lower the mechanical properties of the final part, such as tensile strength and heat resistance.

Accordingly, there remains a need for methods and compositions to achieve ease of processing polyolefins with reduced levels of fluorinated processing aids, without also the use of low weight average molecular weight (Mw) non-fluorinated PPAs.

### SUMMARY

The inventors have found a method of adjusting the polymer processing parameters of a polymer composition comprising a polymer i) by use of reduced levels of fluorinated processing aids in combination with increasing the molecular weight distribution of the polymer i). The molecular weight distribution is characterized by the polydispersity index PDI, which is equal to the weight average molecular weight Mw divided by the number average molecular weight Mn; Mw/Mn. The inventors have surprisingly found that polyolefin polymers having a PDI of 7 or more exhibit a synergistic effect when combined with a fluoropolymer processing aid compared to either approach alone. The effect is apparent in a reduced pressure at the die for the same throughput, for example, compared to using either approach alone.

A composition is also provided. The composition includes:
i) a polymer comprising at least one of propylene or ethylene as a polymerized monomer, the polymer having a peak molecular weight Mp and a polydispersity index PDI of 7 or higher; and
ii) a process aid comprising a fluoropolymer.

### BRIEF DESCRIPTION OF THE DRAWINGS

FIG. 1 shows die pressure with respect to the change in screw speed for 4252 (control), LX3 20-04 (4252 with 200 ppm of FX5911), LX3 20-12 (4252 with broader MWD and no PPA) and LX3 20-12 with 200 ppm of FX5911; and

FIG. 2 shows throughput as a function of change in die pressure for 4252 (control), LX3 20-04 (4252 with 200 ppm of FX5911), LX3 20-12 (4252 with broader MWD and no PPA), and LX3 20-12 with 200 ppm of FX5911.

### DETAILED DESCRIPTION

This disclosure describes a method of adjusting a processing parameter of a polymer by the use of a synergistic combination of polydispersity index PDI of 7 or higher and added polymer processing aid (PPA). The method improves the volumetric output of melt extrusion of polypropylene or polyethylene resins at the same pressure, and also provides a reduced incidence of melt fracture at higher extrusion outputs, compared to comparative compositions that lack the fluorinated PPA, but are otherwise the same; and compared to comparative compositions that include a comparative polymer that has the same peak molecular weight as the polymer having the PDI of 7 or higher, but is otherwise the same. At the same time, physical properties of the extruded part are not adversely impacted compared to the comparative compositions.

Methods

The method of processing a polymer composition comprises steps a) and b).

Step a) is preparing the polymer composition by combining i) a polymer comprising at least one of propylene or ethylene as a polymerized monomer; and ii) a process aid. The polymer i) has a peak molecular weight Mp and a polydispersity index PDI of 7 or higher. As is known in the art, PDI=Mw/Mn, where Mw is the weight average molecular weight and Mn is the number average molecular weight.

Step b) is processing the polymer composition at a processing condition.

A processing parameter is adjusted at the processing condition for the polymer composition compared to both of:
a comparative polymer composition A); and
a comparative polymer composition B).

The comparative polymer composition A) is the same as the polymer composition except that it lacks the process aid ii). The comparative polymer composition B) is the same as the polymer composition except that it comprises a comparative polymer having the same composition and Mp as polymer i), instead of polymer i). Importantly, the comparative polymer has a PDI less than polymer i). According to certain embodiments, the PDI of the comparative polymer may less than 7. For example, the PDI of the comparative polymer may be 6.9, 6.8, 6.7, 6.6, 6.5, 6.4, 6.3, 6.2, 6.1, 6.0, 5.75, 5.5, 5.25, 5.0, or even lower.

Methods of combining the polymer i) with the processing aid include a customary mixing machine, in which the polymer i) and PPA can be melted and mixed with the optional additives. Suitable machines are known to those skilled in the art. Non-limiting examples include mixers, kneaders and extruders. In certain aspects, the process can be carried out in an extruder by introducing the PPA during the polymer processing. Non-limiting examples of extruder can include single-screw extruders, contrarotating and co-rotating twin-screw extruders, planetary-gear extruders, ring extruders, or co-kneaders. Additionally, the polymer i) and the PPA can also be dry-blended and the resulting polymer blend used in typical polymer processes (e.g., blown film extrusion, foam extrusion, sheet extrusion-thermoforming, etc.) In some embodiments, the PPA can be obtained and mixed with the polymer i) and one or more optional additives to produce the polymer blend of the present invention. The polymer i) and the PPA, or blend thereof can be subjected to an elevated temperature for a sufficient period of time during blending. The blending temperature can be above the softening point of the polymer i).

According to an embodiment, the PPA can be incorporated or provided in the form of a masterbatch. As is known in the art, a masterbatch is a composition of a relatively high concentration one or more additives in a carrier resin that is used to proportion he additive(s) accurately into a large bulk of a polymer. If used, the masterbatch may comprise polyethylene, polypropylene and/or the specific polymer i) as the carrier. According to an embodiment, the masterbatch may include from 1 wt % to 80 wt % of the PPA, based on the total weight of the masterbatch.

Processing Parameters and Processing Conditions:

The compositions and methods as disclosed herein are especially suitable for sheet and film extrusions of low MFI polypropylene and polyethylenes and combinations thereof. In particular, the inventors have found that compositions of the polymer i) having a Mp of 7 or higher (especially polyethylene and polypropylene) including the PPAs ii) disclosed herein provide the following measurable effects compared to both comparative polymer composition A) and comparative polymer composition B). The comparative polymer composition A) lacks the process aid ii) but is otherwise identical to the polymer composition. The comparative polymer composition B) comprises a comparative polymer having the same composition and Mp as polymer i). The comparative polymer has a PDI less than polymer i) instead of the polymer i), but is otherwise identical to the polymer i). Thus, the comparative polymer composition B) is identical to the inventive polymer composition, but substitutes the comparative polymer for the polymer i) According to certain embodiments, the PDI of the comparative polymer may less than 7. For example, the PDI of the comparative polymer may be 6.9, 6.8, 6.7, 6.6, 6.5, 6.4, 6.3, 6.2, 6.1, 6.0, 5.75, 5.5, 5.25, 5.0, or even lower.

Polypropylene/polyethylene formulations according to the invention including the PPA and the polymer i) (polypropylene/polyethylene) having a PDI of 7 or higher can reduce or eliminate melt fractures at the same extrusion volume per time compared to a formulation not including the PPA ii) and compared to compositions in which the polypropylene and/or polyethylene in the formulation have a PDI of less than 7, but the same Mp.

Extrusion of polypropylene and/or polyethylene formulations containing the PPA ii) can be done with lower melt pressure and higher extrusion throughputs compared to the same polypropylene and/or polyethylene formulations not containing the PPA ii) and compared to compositions in which the polypropylene and/or polyethylene in the formulation have a PDI of less than 7, but the same Mp.

According to an embodiment, the process aid ii) comprises a fluorinated process aid.

According to an embodiment, the processing parameter is output volume per hour and the processing condition is pressure at a die. According to this embodiment, the output volume for the polymer composition is higher at the same pressure at the die compared to both the comparative polymer composition A); and the comparative polymer composition B).

According to another embodiment, the processing parameter is pressure at a die and the processing condition is output volume per hour, and the pressure at a die is lower for the polymer composition at the same output volume per hour compared to both the comparative polymer composition A); and the comparative polymer composition B).

According to an embodiment, the processing parameter is melt fracture and the processing condition is pressure at a die, and the melt fracture is reduced or absent for the polymer composition at the same pressure at the die hour compared to the comparative polymer composition A); and the comparative polymer composition B).

According to an embodiment, the processing parameter is melt fracture and the processing condition is output volume per hour, and the melt fracture is reduced or absent for the polymer composition compared to: the comparative polymer composition A); and the comparative polymer composition B).

According to an embodiment, the processing parameter is drop in pressure at a die since beginning of an extrusion and the processing condition is time since the beginning of the extrusion, and the drop in pressure at the die is higher for the polymer composition at the same time since the beginning of the extrusion hour compared to the comparative polymer composition A); and the comparative polymer composition B).

Compositions

A composition is also provided. The composition comprises:
i) a polymer comprising at least one of propylene or ethylene as a polymerized monomer, the polymer having a peak molecular weight Mp and a polydispersity index PDI of 7 or higher; and
ii) a fluorinated process aid.

According to an embodiment, the process aid ii) comprises a fluorinated process aid. According to another embodiment, the polymer i) has a melt flow index of from 0.1 to 200 g/10 minutes as measured according to ASTM-D1238-20. The polymer i) may comprise polypropylene having a melt flow index of from 0.1 to 200 g/10 minutes as measured according to ASTM-D1238-20. The polymer composition including the polymer i) and the process aid ii) may comprise from 0.005 wt % to 10 wt % of the process aid ii), by weight of the polymer composition. The polymer i) may comprise at least one of polypropylene homopolymer, isotactic polypropylene, syndiotactic polypropylene, random copolymers of ethylene and propylene, or combinations thereof. The polymer i) may comprise propylene as a polymerized monomer and may further comprise, as a polymerized monomer, up to 6 wt % by weight of the polymer i) of at least one of ethylene, butene, pentene, hexane, or a combination thereof. The polymer i) may comprise polyethylene having a melt flow index of from 0.1 to 200 g/10 minutes as measured according to ASTM-D1238-20.

PDI:

The polydispersity index (PDI), as is known in the art is equal to the weight average molecular weight Mw of the polymer divided by the number average molecular weight Mn of the polymer, Mw/Mn.

The PDI of the polymer is 7 or higher. For example, the PDI of the polymer may be 7, 8, 9, 10, or higher.

Polymers i):

The polymers used in the invention can include polyolefins. Polyolefins can be prepared by any of the polymerization processes, which are in commercial use (e.g., a “high pressure” process, a slurry process, a solution process and/or a gas phase process) and with the use of any of the known catalysts (e.g., Ziegler Natta catalysts, chromium or Phillips catalysts, single site catalysts, metallocene catalysts, and the like). Non-limiting examples of polyolefins include polypropylenes and polyethylenes.

Polyethylenes can include homopolymers of ethylene or copolymers of ethylene with at least one alpha olefin (e.g., butene, hexene, octene and the like). Non-limiting examples of polyethylenes include low density polyethylene (LDPE), a linear low density polyethylene (LLDPE), a medium density polyethylene (MDPE), a high density polyethylene (HDPE), an ethylene copolymer, or blends thereof.

The polyolefin may also be prepared using any other method such as a combination of Ziegler-Natta and metallocene catalysts.

Ziegler-Natta Catalysts

Traditionally, catalyst systems used in bulk loop reactors for the commercial production (polymer production in the range of between 1 and up to 5 tons/hour and desirably between at least 1 ton to at least 50 tons/hour over a period of between at least about 5 days up to at least about 2 years) of polyethylene and polypropylene homopolymers and/or copolymers are commonly known as conventional Ziegler-Natta catalyst systems (hereafter may also be referred to as “Ziegler-Natta catalysts” or “Ziegler-Natta catalyst systems”). Non-limiting examples of conventional Ziegler-Natta catalysts systems can include a Ziegler-Natta catalyst, a support, one or more internal donors, and one or more external donors.

Conventional Ziegler-Natta catalysts are stereospecific complexes formed from a transition metal halide and a metal alkyl or hydride and can produce isotactic polypropylenes. The Ziegler-Natta catalysts are derived from a halide of a transition metal, such as titanium, chromium or vanadium with a metal hydride and/or metal alkyl, typically an organoaluminum compound as a co-catalyst. The catalyst can include a titanium halide supported on a magnesium compound. Ziegler-Natta catalysts, such as titanium tetrachloride (TiCl₄) supported on an active magnesium dihalide, such as magnesium dichloride or magnesium dibromide are supported catalysts. Silica may also be used as a support. The supported catalyst may be employed in conjunction with a co-catalyst such as an alkylaluminum compound, for example, triethylaluminum (TEAL), trimethyl aluminum (TMA) and triisobutyl aluminum (TIBAL).

Conventional Ziegler-Natta catalysts may be used in conjunction with one or more internal electron donors. These internal electron donors are added during the preparation of the catalysts and may be combined with the support or otherwise complexed with the transition metal halide. A suitable Ziegler-Natta catalyst containing a diether-based internal donor compound is that available as Mitsui RK-100 and Mitsui RH-220, both manufactured by Mitsui Chemicals, Inc., Japan. The RK-100 catalyst additionally includes an internal phthalate donor. The Ziegler-Natta catalyst can be a supported catalyst. Suitable support materials include magnesium compounds, such as magnesium halides, dialkoxymagnesiums, alkoxymagnesium halides, magnesium oxyhalides, dialkylmagnesiums, magnesium oxide, magnesium hydroxide, and carboxylates of magnesium. Typical magnesium levels are from about 12% to about 20% by weight of catalyst. The RK-100 catalyst contains approximately 2.3% by weight titanium, with approximately 17.3% by weight magnesium. The RH-220 catalyst contains approximately 3.4% by weight titanium, with approximately 14.5% by weight magnesium.

Conventional Ziegler-Natta catalysts can also be used in conjunction with one or more external donors. Generally, such external donors act as stereoselective control agents to control the amount of atactic or non-stereoregular polymer produced during the reaction, thus reducing the amount of xylene solubles. Examples of external donors include the organosilicon compounds such as cyclohexylmethyl dimethoxysilane (CMDS), dicyclopentyl dimethoxysilane (CPDS) and diisopropyl dimethoxysilane (DIDS). External donors, however, may reduce catalyst activity and may tend to reduce the melt flow of the resulting polymer.

Metallocene Catalyst System

Other catalyst systems useful for polymerizing propylene and ethylene are based upon metallocenes. Metallocenes can be characterized generally as coordination compounds incorporating one or more cyclopentadienyl (Cp) groups (which may be substituted or unsubstituted and may be the same or different) coordinated with a transition metal through n bonding. The Cp groups may also include substitution by linear, branched or cyclic hydrocarbyl radicals and desirably cyclic hydrocarbyl radicals so as to form other contiguous ring structures, including, for example indenyl, azulenyl and fluorenyl groups. These additional ring structures can also be substituted or unsubstituted by hydrocarbyl radicals and desirably C1 to C20 hydrocarbyl radicals. Metallocene compounds may be combined with an activator and/or cocatalyst (as described in greater detail below) or the reaction product of an activator and/or cocatalyst, such as for example methylaluminoxane (MAO) and optionally an alkylation/scavenging agent such as trialkylaluminum compound (TEAL, TMA and/or TIBAL). Various types of metallocenes are known in the art, which may be supported. Typical support may be any support such as talc, an inorganic oxide, clay, and clay minerals, ion-exchanged layered compounds, diatomaceous earth, silicates, zeolites or a resinous support material such as a polyolefin. Specific inorganic oxides include silica and alumina, used alone or in combination with other inorganic oxides such as magnesia, titania, zirconia and the like. Non-metallocene transition metal compounds, such as titanium tetrachloride, are also incorporated into the supported catalyst component. The inorganic oxides used as support are characterized as having an average particle size ranging from 30-600 microns or from 30-100 microns, a surface area of 50-1,000 square meters per gram, or from 100-400 square meters per gram, a pore volume of 0.5-3.5 cc/g, or from about 0.5-2 cc/g.

Any metallocene may be used in the practice of the invention. As used herein unless otherwise indicated, “metallocene” includes a single metallocene composition or two or more metallocene compositions. Metallocenes are typically bulky ligand transition metal compounds generally represented by the formula: [L]ₘM[A]n where L is a bulky ligand, A is a leaving group, M is a transition metal and m and n are such that the total ligand valency corresponds to the transition metal valency. The ligands L and A may be bridged to each other, and if two ligands L and/or A are present, they may be bridged. The metallocene compound may be full-sandwich compounds having two or more ligands L which may be cyclopentadienyl ligands or cyclopentadiene derived ligands or half-sandwich compounds having one ligand L, which is a cyclopentadienyl ligand or cyclopentadienyl derived ligand. The transition metal atom may be a Column 4, 5, or 6 transition metal and/or a metal from the lanthanide and actinide series of the Periodic Table. Non-limiting examples of metals include zirconium, titanium, and hafnium. Other ligands may be bonded to the transition metal, such as a leaving group. Non-limiting examples of ligands include hydrocarbyl, hydrogen or any other univalent anionic ligand. A bridged metallocene, for example, can be described by the general formula: RCpCp′MeQx. Me denotes a transition metal element and Cp and Cp′ each denote a cyclopentadienyl group, each being the same or different and which can be either substituted or unsubstituted, Q is an alkyl or other hydrocarbyl or a halogen group, x is a number and may be within the range of 1 to 3 and R is a structural bridge extending between the cyclopentadienyl rings. Metallocene catalysts and metallocene catalysts systems that produce isotactic polyolefins may be used. These systems include chiral, stereorigid metallocene catalysts that polymerize olefins to form isotactic polymers and are especially useful in the polymerization of highly isotactic polypropylene.

Metallocenes may be used in combination with some form of activator in order to create an active catalyst system. The term “activator” is defined herein to be any compound or component, or combination of compounds or components, capable of enhancing the ability of one or more metallocenes to polymerize olefins to polyolefins. Alklyalumoxanes such as methylalumoxane (MAO) are commonly used as metallocene activators. Generally, alkylalumoxanes contain about 5 to 40 of the repeating units. Alumoxane solutions, particularly methylalumoxane solutions, may be obtained from commercial vendors as solutions having various concentrations. There are a variety of methods for preparing alumoxane. (As used herein unless otherwise stated “solution” refers to any mixture including suspensions.)

Ionizing activators may also be used to activate metallocenes. These activators are neutral or ionic, or are compounds such as tri(n-butyl)ammonium tetrakis(pentaflurophenyl)borate, which ionize the neutral metallocene compound. Such ionizing compounds may contain an active proton, or some other cation associated with, but not coordinated or only loosely coordinated to, the remaining ion of the ionizing compound. Combinations of activators may also be used, for example, alumoxane and ionizing activators in combination.

Ionic catalysts for coordination polymerization comprised of metallocene cations activated by non-coordinating anions may be used. A method of preparation wherein metallocenes (bisCp and monoCp) are protonated by an anion precursor such that an alkyl/hydride group is abstracted from a transition metal to make it both cationic and charge-balanced by the non-coordinating anion is suitable. Suitable ionic salts include tetrakis-substituted borate or aluminum salts having fluorided aryl-constituents such as phenyl, biphenyl and napthyl.

The term “noncoordinating anion” (“NCA”) means an anion which either does not coordinate to said cation or which is only weakly coordinated to said cation thereby remaining sufficiently labile to be displaced by a neutral Lewis base. “Compatible” noncoordinating anions are those which are not degraded to neutrality when the initially formed complex decomposes. Further, the anion will not transfer an anionic substituent or fragment to the cation so as to cause it to form a neutral four coordinate metallocene compound and a neutral by-product from the anion.

The use of ionizing ionic compounds not containing an active proton but capable of producing both the active metallocene cation and a noncoordinating anion is also known. An additional method of making the ionic catalysts uses ionizing anion precursors which are initially neutral Lewis acids but form the cation and anion upon ionizing reaction with the metallocene compounds, for example the use of tris(pentafluorophenyl) borane. Ionic catalysts for addition polymerization can also be prepared by oxidation of the metal centers of transition metal compounds by anion precursors containing metallic oxidizing groups along with the anion groups.

Where the metal ligands include halogen moieties (for example, bis-cyclopentadienyl zirconium dichloride) which are not capable of ionizing abstraction under standard conditions, they can be converted via known alkylation reactions with organometallic compounds such as lithium or aluminum hydrides or alkyls, alkylalumoxanes, Grignard reagents, etc. In situ processes of the reaction of alkyl aluminum compounds with dihalo-substituted metallocene compounds prior to or with the addition of activating anionic compounds may be used.

Suitable methods for supporting ionic catalysts comprising metallocene cations and NCA are known. When using the support composition, these NCA support methods can include using neutral anion precursors that are sufficiently strong Lewis acids to react with the hydroxyl reactive functionalities present on the silica surface such that the Lewis acid becomes covalently bound. Additionally, when the activator for the metallocene supported catalyst composition is an NCA, desirably the NCA is first added to the support composition followed by the addition of the metallocene catalyst. When the activator is MAO, desirably the MAO and metallocene catalyst are dissolved together in solution. The support is then contacted with the MAO/metallocene catalyst solution. Other methods and order of addition will be apparent to those skilled in the art.

The polyolefin may be formed by placing one or more olefin monomer (e.g., ethylene, propylene) alone or with other monomers in a suitable reaction vessel in the presence of a catalyst (e.g., Ziegler-Natta, metallocene, etc.) and under suitable reaction conditions for polymerization thereof. Any suitable equipment and processes for polymerizing the olefin into a polymer may be used. For example, such processes may include solution phase, gas phase, slurry phase, bulk phase, high pressure processes or combinations thereof.

Polyolefins can be formed by a gas phase polymerization process. One example of a gas phase polymerization process includes a continuous cycle system, wherein a cycling gas stream (otherwise known as a recycle stream or fluidizing medium) is heated in a reactor by heat of polymerization. The heat is removed from the cycling gas stream in another part of the cycle by a cooling system external to the reactor. The cycling gas stream containing one or more monomers may be continuously cycled through a fluidized bed in the presence of a catalyst under reactive conditions. The cycling gas stream is generally withdrawn from the fluidized bed and recycled back into the reactor. Simultaneously, polymer product may be withdrawn from the reactor and fresh monomer may be added to replace the polymerized monomer. The reactor pressure in a gas phase process may vary from 100 psig to 500 psig, or from 200 psig to 400 psig, or from 250 psig to 350 psig. The reactor temperature in a gas phase process can be from 30° C. to 120° C. or from 60° C. to 115° C. or from 70° C. to 110° C. or from 70° C. to 95° C.

Polypropylene

The polypropylene resin may include polypropylene homopolymer, random copolymer, impact copolymers, and combinations thereof. The polypropylene resin may be produced with Ziegler Natta catalysts or metallocene catalysts. Polypropylenes include homopolymers of propylene, copolymers of propylene and other olefins, and terpolymers of propylene, ethylene, and dienes. The polypropylene may be a reactor grade (i.e., as produced from the reactor) or may be a tailored polypropylene, such as a controlled rheology or “vis-broken” grade. A controlled rheology grade polypropylene (CRPP) or “vis-broken” grade polypropylene is one that has been further processed (e.g., through a degradation process) to produce a polypropylene polymer with a targeted melt flow index (MFI), targeted molecular weight, and/or a narrower molecular weight distribution than the starting polypropylene.

According to an embodiment, the polymer i) may comprise at least one of polypropylene homopolymer, isotactic polypropylene, syndiotactic polypropylene, random copolymers of ethylene and propylene, or combinations thereof. The polymer i) may comprises propylene as a polymerized monomer and further comprises, as a polymerized monomer, up to 6 wt % by weight of the polymer i) of at least one of ethylene, butene, pentene, hexene, or a combination thereof. The polymer i) may comprise polypropylene having a melt flow index of from 0.1 to 200 g/10 minutes as measured according to ASTM-D1238-20. The melt flow index of the polypropylene may be from 0.5 to 100 g/10 minutes. For example, the melt flow index pf the polypropylene may be from 0.1 to 5 g/10 minutes or from 1 to 8 g/10 minutes. According to various embodiments, the melt flow index of the polypropylene may be at least 0.5, 0.6, 0.7, 0.8, 0.9, 1, 1.2, 1.4, 1.6, 1.8, 2.0, 2.2, 2.4, 2.6, 2.8, 3.0, 3.2, 3.4, 3.6, 3.8, 4.0, 4.2, 4.4, 4.6, 4.8, 5.0, 5.2, 5.4, 5.6, 5.8, 6.0, 6.2, 6.4, 6.6, 6.8, 7.0, 7.2, 7.4, 7.6, 7.8, 8.0, 8.2, 8.4, 8.6, 8.8, 9.0, 9.2, 9.4, 9.6, 9.8, 10, 11, 12, 13, 14, 15, 16, 17, 18, 19, 20, 25, 30, 35, 40, 45, 50, 55, 60, 65, 70, 75, 80, 85, 90, 95, 100, 125, 150, 175 or at least 200 g/10 minutes as measured according to ASTM-D1238-20 using a 5 kg weight. According to various embodiments, the melt flow index of the polypropylene may be at most 200, 175, 150, 125, 100, 95, 90, 85, 80, 75, 70, 65, 60, 55, 50, 45, 40, 35, 30, 25, 20, 15, 14, 13, 12, 11, 10.0, 9.8, 9.6, 9.4, 9.2, 9.0, 8.8, 8.6, 8.4, 8.2, 8.0, 7.8, 7.6, 7.4, 7.2, 7.0, 6.8, 6.6, 6.4, 6.2, 6.0, 5.8, 5.6, 5.4, 5.2, 5.0, 4.8, 4.6, 4.4, 4.2, 4.0, 3.8, 3.6, 3.4, 3.2, 3.0, 2.8, 2.6, 2.4, 2.2, 2.0, 1.8, 1.6, 1.4, 1.2, 1.0, 0.9, 0.8, 0.7, 0.6, 0.5, 0.4, 0.3, or at most 0.2 g/10 minutes as measured according to ASTM-D1238-20 using a 5 kg weight.

The polypropylene can be produced using any catalyst known in the art, such as chromium catalysts, Ziegler-Natta catalysts and/or metallocene catalysts as discussed above.

Polyethylene

According to an embodiment, the polymer i) comprises polyethylene having a melt flow index of from 0.1 to 200 g/10 minutes as measured according to ASTM-D1238-20 using a 5 kg weight. The melt flow index of the polyethylene may be from 0.5 to 100 g/10 minutes. For example, the melt flow index pf the polyethylene may be from 0.1 to 5 g/10 minutes or from 1 to 8 g/10 minutes. According to various embodiments, the melt flow index of the polyethylene may be at least 0.5, 0.6, 0.7, 0.8, 0.9, 1, 1.2, 1.4, 1.6, 1.8, 2.0, 2.2, 2.4, 2.6, 2.8, 3.0, 3.2, 3.4, 3.6, 3.8, 4.0, 4.2, 4.4, 4.6, 4.8, 5.0, 5.2, 5.4, 5.6, 5.8, 6.0, 6.2, 6.4, 6.6, 6.8, 7.0, 7.2, 7.4, 7.6, 7.8, 8.0, 8.2, 8.4, 8.6, 8.8, 9.0, 9.2, 9.4, 9.6, 9.8, 10, 11, 12, 13, 14, 15, 16, 17, 18, 19, 20, 25, 30, 35, 40, 45, 50, 55, 60, 65, 70, 75, 80, 85, 90, 95, 100, 125, 150, 175 or at least 200 g/10 minutes as measured according to ASTM-D1238-20 using a 5 kg weight. According to various embodiments, the melt flow index of the polyethylene may be at most 200, 175, 150, 125, 100, 95, 90, 85, 80, 75, 70, 65, 60, 55, 50, 45, 40, 35, 30, 25, 20, 15, 14, 13, 12, 11, 10.0, 9.8, 9.6, 9.4, 9.2, 9.0, 8.8, 8.6, 8.4, 8.2, 8.0, 7.8, 7.6, 7.4, 7.2, 7.0, 6.8, 6.6, 6.4, 6.2, 6.0, 5.8, 5.6, 5.4, 5.2, 5.0, 4.8, 4.6, 4.4, 4.2, 4.0, 3.8, 3.6, 3.4, 3.2, 3.0, 2.8, 2.6, 2.4, 2.2, 2.0, 1.8, 1.6, 1.4, 1.2, 1.0, 0.9, 0.8, 0.7, 0.6, 0.5, 0.4, 0.3, or at most 0.2 g/10 minutes as measured according to ASTM-D1238-20 using a 5 kg weight.

For the purposes of the present application, the term “polyethylene” or “polyethylene polymer” is synonymous and is used to denote ethylene homopolymer as well as ethylene copolymers. If the polyethylene is a copolymer, the comonomer can be any alpha-olefin i.e. any 1-alkylene comprising from 2 to 12 carbon atoms, for example, ethylene, propylene, 1-butene, and 1-hexene. The copolymer can be an alternating, periodic, random, and statistical or block copolymer. Preferably, the polyethylene used in the invention is a homopolymer or a copolymer of ethylene and hexene or butene.

The polyethylene can be produced using any catalyst known in the art, such as chromium catalysts, Ziegler-Natta catalysts and/or metallocene catalysts as discussed above.

The polymer i) may be a blend of polypropylene and polyethylene. For example, the composition may include from 1 wt % to 99 wt % of polyethylene and/or a copolymer thereof and from 99 wt % to 1 wt % of polypropylene and/or a copolymer thereof, based on the total weight of the polyethylene and polypropylene in the composition. For example, the composition may include at least 1, 2, 5, 10, 15, 20, 30, 40, 50, 60, 70, 80, 85, 90, 95, 98, or at least 99 wt % of polyethylene and/or a copolymer thereof, based on the total weight polypropylene and polyethylene and copolymers thereof in the composition. The composition may include at most 99, 98, 95, 90, 85, 80, 70, 60, 50, 40, 30, 20, 15, 10, 5, 2, or at most 1 wt % polyethylene and/or a copolymer thereof, based on the total weight polypropylene and polyethylene and copolymers thereof in the composition. For example, the composition may include at least 1, 2, 5, 10, 15, 20, 30, 40, 50, 60, 70, 80, 85, 90, 95, 98, or at least 99 wt % of polypropylene and/or a copolymer thereof, based on the total weight of the polypropylene and polyethylene and copolymers thereof in the composition. The composition may include at most 99, 98, 95, 90, 85, 80, 70, 60, 50, 40, 30, 20, 15, 10, 5, 2, or at most 1 wt % polypropylene and/or a copolymer thereof, based on the total weight polypropylene and polyethylene and copolymers thereof.

Processing Aids ii)

The process aids may also be referred to as lubricants. According to an embodiment, the process aid ii) comprises a fluorinated process aid. Non-limiting examples of fluorinated processing aids ii) are fluoropolymer-based processing aids. These may be copolymers of vinylidene fluoride and hexafluoropropylene. Suitable fluoropolymers include but are not limited to homopolymers and copolymers that comprise structural units derived from one or more fluorinated alpha-olefin monomers, that is, an alpha-olefin monomer that includes at least one fluorine atom in place of a hydrogen atom. In an embodiment, the fluoropolymer comprises structural units derived from at least one or more fluorinated alpha-olefin, for example tetrafluoroethylene, hexafluoroethylene, and the like. In an embodiment, the fluoropolymer comprises structural units derived from one or more fluorinated alpha-olefin monomers and one or more non-fluorinated monoethylenically unsaturated monomers that are copolymerizable with the fluorinated monomers, for example alpha-monoethylenically unsaturated copolymerizable monomers such as ethylene, propylene, butene, acrylate monomers (e.g., methyl methacrylate and butyl acrylate), vinyl ethers, (e.g., cyclohexyl vinyl ether, ethyl vinyl ether, n-butyl vinyl ether, vinyl esters) and the like. Specific examples of fluoropolymers include poly(tetrafluoroethylene), poly(hexafluoropropylene), poly(vinylidene fluoride), poly(chlorotrifluoroethylene), poly(ethylene-tetrafluoroethylene), fluorinated ethylene-propylene polymer, poly(vinyl fluoride), and poly(ethylene-chlorotrifluoroethylene). Combinations comprising at least one of the foregoing fluoropolymers can also be used as the processing aids. Suitable such processing aids are those sold under the tradenames of Dynamar™ (3M), Kynar® (Arkema), Viton™ (Viton), for example.

The polymer composition may comprise from 0.005 wt % to 10 wt % of the process aid ii), by weight of the polymer composition. The polymer composition may include from 0.01 to 5 wt % pf the processing aid. The polymer composition may include from 0.015 to 0.05 wt % of the processing aid. The polymer composition may include at least 0.005, 0.006, 0.007, 0.008, 0.009, 0.010, 0.015, 0.02, 0.025, 0.03, 0.035, 0.04, 0.045, 0.05, 0.055, 0.06, 0.065, 0.07, 0.075, 0.08, 0.085, 0.09, 0.095, 0.1, 0.2, 0.3, 0.4, 0.5, 0.6, 0.7, 0.8, 0.9, 1, 1.5, 2, 2.5, 3, 3.5, 4, 4.5, 5, 5.5, 6, 6.5, 7, 7.5, 8, 8.5, 9, or at least 9.5 wt % of the processing aid. The polymer composition may include at most 10, 9.9, 9.8, 9.7, 9.8, 9.7, 9.6, 9.5, 9.4, 9.3, 9.2, 9.1, 9, 8.5, 8, 7.5, 7, 6.5, 6, 5.5, 5, 4.5, 4.4, 4.3, 4.2, 4.1, 4, 3.9, 3.8, 3.7, 3.8, 3.6, 3.5, 3.4, 3.3, 3.2, 3.1, 3.0, 2.9, 2.8, 2.7, 2.6, 2.5, 2.4, 2.3, 2.2, 2.1, 2.0, 1.9, 1.8, 1.7, 1.6, 1.5, 1.4, 1.3, 1.2, 1.1, 1, 0.9, 0.8, 0.7, 0.6, 0.5, 0.4, 0.3, 0.2, 0.1, 0.09, 0.08, 0.07, 0.06, 0.05, 0.04, 0.03, 0.02, 0.01, 0.009, 0.008, 0.007, or at most 0.006 wt % of the process aid.

Peak Molecular Weight Mp

As discussed above, the polymer i) which may be polypropylene and/or polyethylene has a peak molecular weight, Mp, defined as the molecular weight at the peak of a distribution curve. It is envisaged that the polymer i) may have more than one peak molecular weight, i.e., have a multimodal distribution. In that case, there will be more than one Mp and the comparative polymer having the same Mp as polymer i) will also be multimodal, having the same one or more Mps as the polymer i), but a lower PDI than the polymer i). The Mp or Mps are not particularly limited. For example, an Mp of polymer i) may be from 2000 to 2,000,000 g/mol.

Other Additives:

The polymer compositions of the present invention can further include at least one additive, in addition to the PPA ii). Non-limiting examples of additives include an antiblocking agent, an antistatic agent, an antioxidant, a neutralizing agent, a blowing agent, a crystallization aid, a dye, a flame retardant, a filler, an impact modifier, a mold release agent, an oil, another polymer, a pigment, a processing agent, a reinforcing agent, a nucleating agent, a clarifying agent, a slip agent other than a PPA, a flow modifier other than a PPA, a stabilizer, an UV resistance agent, and combinations thereof Additives are available from various commercial suppliers. Non-limiting examples of commercial additive suppliers include BASF (Germany), Dover Chemical Corporation (U.S.A.), AkzoNobel (The Netherlands), Sigma-Aldrich® (U.S.A.), Atofina Chemicals, Inc., and the like.

### EXAMPLES

Molecular Weight Measurement:

For all of the polymers tested, the weight average molecular weight Mw, number average molecular weight Mn, z-average molecular weight Mz, and peak molecular weight Mp were measured by gel permeation chromatography, also referred to as size exclusion chromatography, using an Agilent Technologies 7890A GC System with 1,2,4-trichlorobenzene (TCB) as solvent and polystyrene standards. A mass spectrometer was used as the detector.

Extrusions:

All of the extrusion testing was performed as follows. The die gap on a slot die of a mini coextrusion line (Davis Standard 1 inch diameter screw with 25/1 LID and a Davis Standard 3 chrome roll take off unit) was set to minimum thickness (4 mil, 1.016 mm) and the purging was carried out at 100 rpm using the control material (4252 polypropylene, TotalEnergies) for 45 minutes before collecting the corresponding data and samples for throughputs for the 4252. This was followed by the extrusion of the broad molecular weight (BMWD) version of 4252 (LX3 20-12 polypropylene, TotalEnergies) for another 45 minutes before starting the collection of the samples and data points. The polymer compositions including the added PPA [LX3 20-04 followed by LX3 20-12 including 200 ppm wt of DynamarTMFX5911 (fluoropolymer, 3M™)] were extruded next, in succession, with the above-mentioned purge in between for 2.5 hours (each) before collecting the corresponding results. In between these two batches, there was an additional extrusion of LX3 20-12 (with no added PPA) for an hour to purge out the coating of fluoropolymer from the previous run of LX3 20-04. These chronologies of tests were maintained to ensure that fluoropolymer PPAs from a previous batch do not influence the results of a subsequent batch. When switching to different speeds (rpms) (100->80->60->40->20 rpm) there was a wait period of at least 2 minutes before collecting data, to ensure that the die pressure reached an equilibrium state before taking note of the outputs and pressures at the die for each composition.

The operating conditions for the extruder and the take-up rolls for the extruded film as shown in Table 1.

TABLE 1
Extrusion conditions

| | |
|---|---|
| Zone 1(feed) temperature | 420° F. |
| Zone 2 temperature | 440° F. |
| Zone 3 temperature | 480° F. |
| Screw speed | 20-100 rpm |
| Motor load | 20-44% max |
| Melt temperature | 450-460° F. |
| Melt pressure at die | Variable (measured) |
| Clamp temperature | 480° F. |
| Adaptor temperature | 480° F. |
| Feedblock temperature | 480° F. |
| Top roll | N/A |
| Middle roll | 110° F. |
| Bottom roll | 110° F. |
| Die gap | 4 mil |

The polymers used in the Examples are shown in Table 2.

TABLE 2
Samples used in the Examples of Table 1

| | Compar- | | | invention |
|---|---|---|---|---|
| | ative | | | LX3 |
| | (control) | comparative | comparative | 20-12 + |
| | 4252 | LX3 20-04 | LX3 20-12 | FX5911 |
| Mn, gm/mol | 69,344 | 71,001 | 65,538 | 65,538 |
| Mw, gm/mol | 463,658 | 492,319 | 480,038 | 480,038 |
| Mz, gm/mol | 2,234,472 | 2,462,740 | 2,447,171 | 2,447,171 |
| PDS (Mw/Mn) | 6.69 | 6.93 | 7.33 | 7.33 |
| Mp, gm/mol | 199,180 | 204,872 | 199,180 | 199,180 |
| Dynamar ™FX5911 | 0 | 200 | 0 | 200 |
| PPA, ppm wt | | | | |

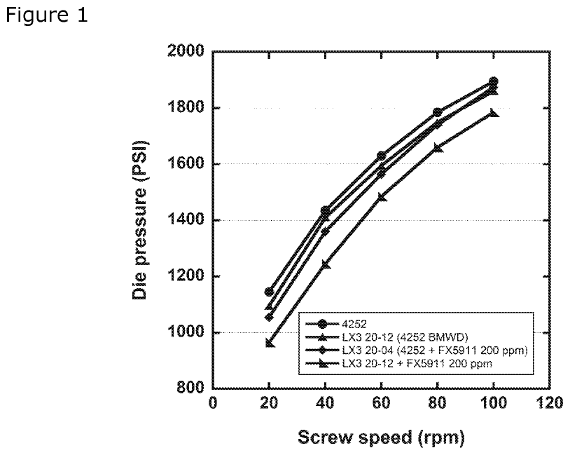

FIG. 1 shows die pressure with respect to the change in screw speed for 4252 (control), LX3 20-04 (4252 with 200 ppm of FX5911), LX3 20-12 (4252 with broader MWD and no PPA) and LX3 20-12 with 200 ppm of FX5911. As can be seen in FIG. 1, it was found that both the broadening of MWD and addition of 200 ppm of FX5911 could individually lower the pressure more than the pressure for 4252. However, when both factors of additive and broadening MWD were combined, there was noticeable decrease in the die pressure, which can be attributed to the synergistic effect of both the broader molecular weight distribution and the PPA.

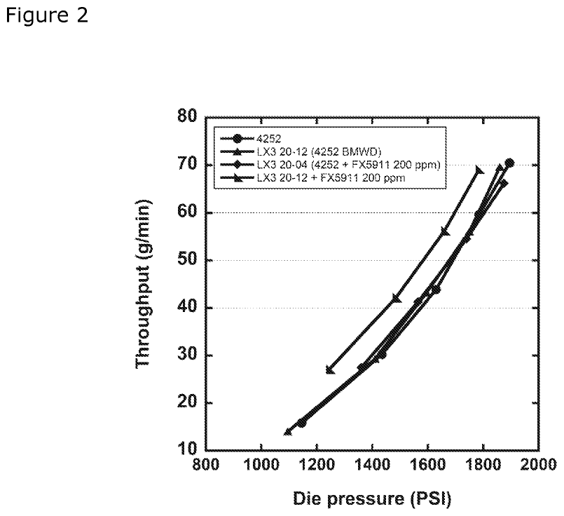

Plotting the throughputs with respect to die pressure as shown in FIG. 2 makes the surprising synergistic effect more obvious. It shows that, irrespective of the extrusion speed, combining both the FX5911 PPA with the broader molecular weight distribution polymer results in higher throughputs than either alone. Moreover, the effect is more than the mere additive effect of each separate effect.

These results as shown in the above examples demonstrate the synergistic effect of the fluorinated polymer in combination with a polymer having a PDI of 7 or higher but maintaining the Mp. As shown in the results, the effect of the combination was to decrease the melt pressure during processing, and thus provide higher throughputs compared to using either approach (fluorinate PPA and broader PCI) alone.

What is claimed is:

1. A method of processing a polymer composition, comprising:
a) preparing the polymer composition by combining
i) a polymer comprising at least one of propylene or ethylene as a polymerized monomer, the polymer having a peak molecular weight Mp and a polydispersity index PDI is 7 or higher; and
ii) a process aid; and
b) processing the polymer composition at a processing condition;
wherein a processing parameter is adjusted at the processing condition for the polymer composition compared to:
a comparative polymer composition A); and
a comparative polymer composition B);
wherein:
the comparative polymer composition A) is the same as the polymer composition except that it lacks the process aid ii); and
the comparative polymer composition B) is the same as the polymer composition except that it comprises a comparative polymer that has the same composition and Mp as the polymer i), but has a lower PDI than the polymer i).

2. The method of claim 1, wherein the processing parameter is output volume per hour and the processing condition is pressure at a die, and the output volume for the polymer composition is higher at the same pressure at the die compared to:
the comparative polymer composition A); and
the comparative polymer composition B).

3. The method of claim 1, wherein the processing parameter is pressure at a die and the processing condition is output volume per hour, and the pressure at a die is lower for the polymer composition at the same output volume per hour compared to:
the comparative polymer composition A); and
the comparative polymer composition B).

4. The method of claim 1, wherein the processing parameter is melt fracture and the processing condition is pressure at a die, and the melt fracture is reduced or absent for the polymer composition at the same pressure at the die hour compared to:
the comparative polymer composition A); and
the comparative polymer composition B).

5. The method of claim 1, wherein the processing parameter is melt fracture and the processing condition is output volume per hour, and the melt fracture is reduced or absent for the polymer composition compared to:
the comparative polymer composition A); and
the comparative polymer composition B).

6. The method of claim 1, wherein the processing parameter is drop in pressure at a die since beginning of an extrusion and the processing condition is time since the beginning of the extrusion, and the drop in pressure at the die is higher for the polymer composition at the same time since the beginning of the extrusion hour compared to:
the comparative polymer composition A); and
the comparative polymer composition B).

7. The method of claim 1, wherein the process aid ii) comprises a fluorinated process aid.

8. The method of claim 1, wherein the polymer i) has a melt flow index of from 0.1 to 200 g/10 minutes as measured according to ASTM-D1238-20.

9. The method of claim 1, wherein the polymer i) comprises polypropylene having a melt flow index of from 0.1 to 200 g/10 minutes as measured according to ASTM-D1238-20.

10. The method of claim 1, wherein the polymer composition comprises from 0.005 wt % to 10 wt % of the process aid ii), by weight of the polymer composition.

11. The method of claim 1, wherein the polymer i) comprises at least one of polypropylene homopolymer, isotactic polypropylene, syndiotactic polypropylene, random copolymers of ethylene and propylene, or combinations thereof.

12. The method of claim 1, wherein the polymer i) comprises propylene as a polymerized monomer and further comprises, as a polymerized monomer, up to 6 wt % by weight of the polymer i) of at least one of ethylene, butene, pentene, hexane, or a combination thereof.

13. The method of claim 1, wherein the polymer i) comprises polyethylene having a melt flow index of from 0.1 to 200 g/10 minutes as measured according to ASTM-D1238-20.

14. A composition comprising:
i) a polymer comprising at least one of propylene or ethylene as a polymerized monomer, the polymer having a peak molecular weight Mp and a polydispersity index PDI of 7 or higher; and
ii) a fluorinated process aid.

15. The composition of claim 14, wherein the polymer i) has a melt flow index of from 0.1 to 200 g/10 minutes as measured according to ASTM-D1238-20.

16. The composition of claim 14, wherein the polymer i) comprises polypropylene having a melt flow index of from 0.1 to 200 g/10 minutes as measured according to ASTM-D1238-20.

17. The composition of claim 14, wherein the polymer composition comprises from 0.005 wt % to 10 wt % of the process aid ii), by weight of the polymer composition.

18. The composition of claim 14, wherein the polymer i) comprises at least one of polypropylene homopolymer, isotactic polypropylene, syndiotactic polypropylene, random copolymers of ethylene and propylene, or combinations thereof.

19. The composition of claim 14, wherein the polymer i) comprises propylene as a polymerized monomer and further comprises, as a polymerized monomer, up to 6 wt % by weight of the polymer i) of at least one of ethylene, butene, pentene, hexane, or a combination thereof.

20. The composition of claim 14, wherein the polymer i) comprises polyethylene having a melt flow index of from 0.1 to 200 g/10 minutes as measured according to ASTM-D1238-20.
